(19) United States
(12) Patent Application Publication
(10) Pub. No.: US 2006/0289358 A1
(43) Pub. Date: Dec. 28, 2006

(54) Methods and apparatus for removing contaminants from storm water

(75) Inventor: Frank Milchuck, Raleigh, NC (US)

Correspondence Address: MYERS BIGEL SIBLEY & SAJOVEC, PO BOX 37428, RALEIGH, NC, 27627, US

(73) Assignee: GeoSpec, Inc.

(21) Appl. No.: 11/158,401

(22) Filed: Jun. 22, 2005

(51) Int. Cl. C02F 1/52

(52) U.S. Cl. 210/702; 210/205

(57) ABSTRACT

A method for removing contaminant particles from storm water includes: providing a pre-mixed flocculant solution including a water-soluble flocculant and a quantity of solvent water; and thereafter mixing the pre-mixed flocculant solution with the storm water to form treated water wherein flocculants of the pre-mixed flocculant solution are bound with the contaminant particles in the storm water to form flocculated particles. The method may further include mixing the water-soluble flocculant in the quantity of the solvent water for at least a prescribed amount of time to form the pre-mixed flocculant solution prior to mixing the pre-mixed flocculant solution with the storm water to form the treated water.

### FIELD OF THE INVENTION

The present invention relates to methods and apparatus for treating storm water and, more particularly, to methods and apparatus for removing contaminants from storm water.

### BACKGROUND OF THE INVENTION

Vegetation and other erosion controls are often removed from construction sites and the like. As a result, storm water that runs off from such sites may include various contaminants such as suspended solids (e.g., sediment or soil particles and other particles which may be attached to the soil particles), metals, oil and chemicals. Such runoff is often regulated in accordance with stringent water quality standards so that the storm water runoff must be collected and treated before being discharged into the environment.

Storm water runoff regulations include limitations in the maximum allowable water turbidity or dissolved solids (which may be referred to as total suspended solids (TSS)). Water turbidity is caused by small suspended particles of soil. Larger particles may be removed from storm water runoff using filters, settling pools or other conventional sediment control measures. However, many smaller particles cannot be effectively removed by these techniques because they are too small for effective filtering and tend to remain in colloidal suspension. In accordance with some known methods and apparatus, a water soluble flocculating agent or flocculant is mixed with storm water by adding the flocculant to a pool of the collected storm water or placing the flocculant in a flow of the storm water. The flocculant aggregates with the particles to form flocs, which may thereafter be removed as large particles (e.g., by filtering or settling). Exemplary flocculants include multi-valent cations such as calcium, magnesium and aluminum, as well as long chain polymers. The flocculants may themselves present environmental hazards and their use may also be regulated.

### SUMMARY OF THE INVENTION

According to embodiments of the present invention, a method for removing contaminant particles from storm water includes: providing a pre-mixed flocculant solution including a water-soluble flocculant and a quantity of solvent water; and thereafter mixing the pre-mixed flocculant solution with the storm water to form treated water wherein flocculants of the pre-mixed flocculant solution are bound with the contaminant particles in the storm water to form flocculated particles. The method may further include mixing the water-soluble flocculant in the quantity of the solvent water for at least a prescribed amount of time to form the pre-mixed flocculant solution prior to mixing the pre-mixed flocculant solution with the storm water to form the treated water.

According to further embodiments of the present invention, an apparatus for removing contaminant particles from storm water includes a holding tank adapted to contain a pre-mixed flocculant solution including a water-soluble flocculant and a quantity of solvent water. The apparatus further includes a treatment system adapted to mix the pre-mixed flocculant solution from the holding tank with the storm water to form treated water wherein flocculants of the pre-mixed flocculant solution are bound with the contaminant particles in the storm water to form flocculated particles.

Further features, advantages and details of the present invention will be appreciated by those of ordinary skill in the art from a reading of the figures and the detailed description of the preferred embodiments that follow, such description being merely illustrative of the present invention.

### BRIEF DESCRIPTION OF THE DRAWINGS

FIG. 1 is schematic view of a storm water decontamination system according to embodiments of the present invention;

FIG. 2 is a flocculant supply system forming a part of the storm water decontamination system of FIG. 1;

FIG. 3 is a block diagram representing components of the flocculant supply system of FIG. 2; and

FIG. 4 is a fragmentary schematic view of a storm water decontamination system according to further embodiments of the present invention.

### DETAILED DESCRIPTION OF EMBODIMENTS OF THE INVENTION

The present invention now will be described more fully hereinafter with reference to the accompanying drawings, in which illustrative embodiments of the invention are shown. In the drawings, the relative sizes of regions or features may be exaggerated for clarity. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that when an element is referred to as being “coupled” or “connected” to another element, it can be directly coupled or connected to the other element or intervening elements may also be present. In contrast, when an element is referred to as being “directly coupled” or “directly connected” to another element, there are no intervening elements present. Like numbers refer to like elements throughout. As used herein the term “and/or” includes any and all combinations of one or more of the associated listed items.

In addition, spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly.

Well-known functions or constructions may not be described in detail for brevity and/or clarity.

As used herein the expression “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, “storm water” means rainwater that falls on and/or flows across a site such as a construction site.

“Flocculant” or “flocculating agent” refers to a chemical that causes suspended particles to clump together with the flocculant to form flocculated particles or floccules (also referred to as flocs). The flocculant may be an organic compound such as a long chain polymer. In use, the flocculant adsorbs onto and between particles in the suspension to bridge the particles, thereby forming the flocs. For example, segments of a long chain polymer flocculant may adsorb onto respective particles to thereby bridge those particles into a larger agglomerated mass. The flocs are thus aggregations of particles from the suspension.

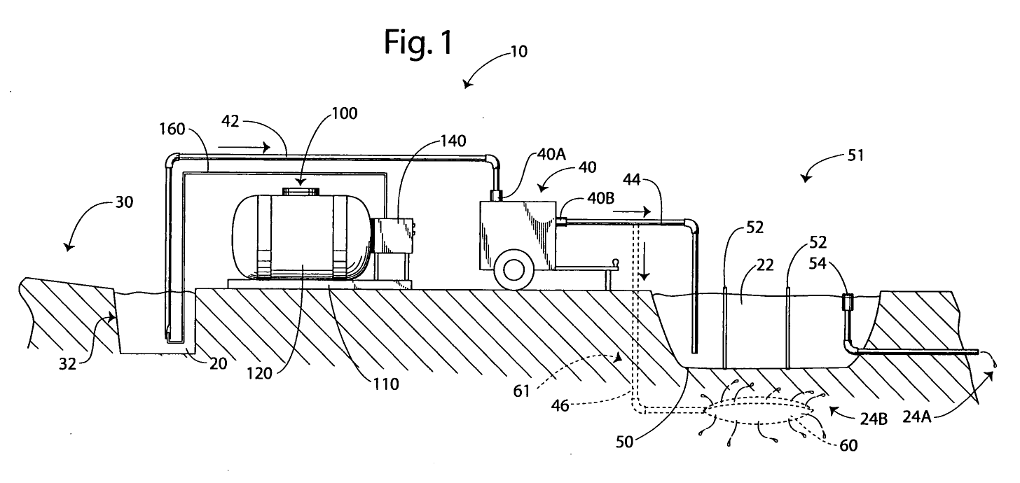

With reference to FIG. 1, a storm water decontamination system 10 according to embodiments of the present invention is shown therein. The system 10 includes a transfer pump 40, a flocculant supply system 100, and a filtering system 51. The system 10 may be used to remove undesirable particles from storm water. For example, as illustrated, storm water 20 (which may be referred to as “dirty water”) may be runoff water from a site 30. The site 30 may be, for example, a construction site. The system 10 may be used to treat the dirty water at or proximate the site 30 so that it is not necessary to transfer the dirty water to a remote location by vehicle or an extensive conduit network or to allow it to run off the site, for example.

The storm water runoff or dirty water 20 may be collected in a tank or basin 32 (as shown, a basin). The dirty water 20 may be routed to the basin 32 by gravity and/or may be transferred to the basin 32 by a pump or the like. Suitable techniques and apparatus for collecting the dirty water 20 will be apparent to those of skill in the art.

In known manner, the dirty water 20 is drawn by the transfer pump 40 through a take-up conduit 42 and conveyed through a discharge conduit 44 to the filtering system 51. In accordance with embodiments of the present invention, the dirty water 20 is additionally treated with a flocculant (provided in a flocculant solution 102) prior to being discharged to the filtering system 51, as discussed in more detail below, to flocculate small particles in the dirty water 20 into relatively larger flocs, thereby converting the dirty water 20 into treated water 22. The treated water 22 is passed through the filtering system 51, which serves to remove the flocs from the treated water 22, thereby converting the treated water 22 to filtered water 24A.

The transfer pump 40, which may also be referred to as a dewatering pump, may be any suitable pump. According to some embodiments, the pump 40 is a centrifugal pump, a diaphragm pump or a sump pump. Exemplary pumps include centrifugal pumps available from Thompson Pumps. The pump 40 includes an intake 40A, a discharge 40B, a drive (not shown), and a displacer (not shown). The drive may include, for example, an electric or internal combustion motor. The displacer may include an impeller, for example. The displacer is operably connected to the drive to generate a pressure head between the intake 40A and the discharge 40B to draw water from the conduit 42 and push the water through the conduit 44.

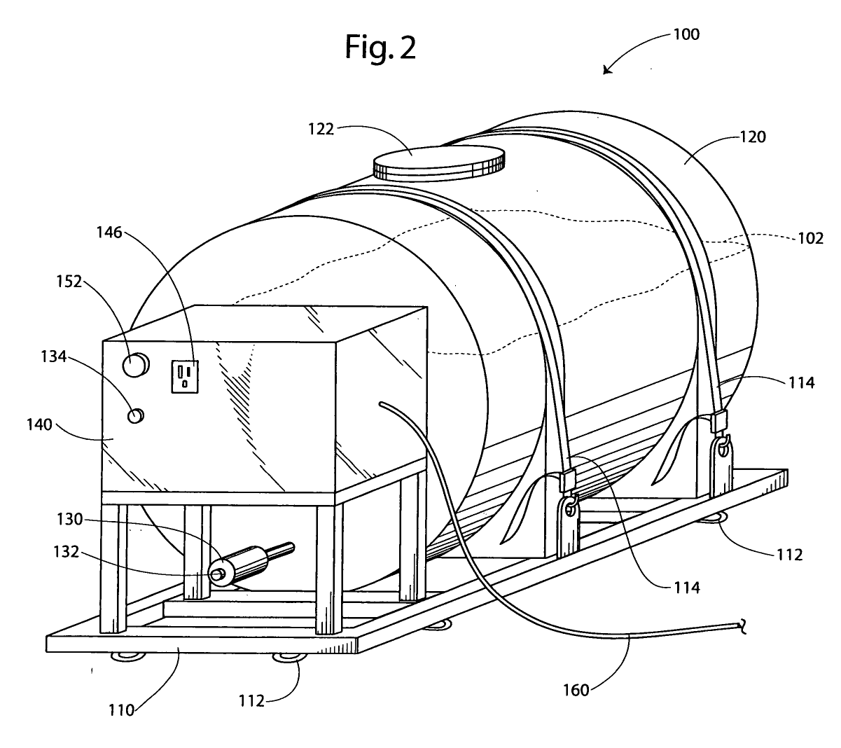

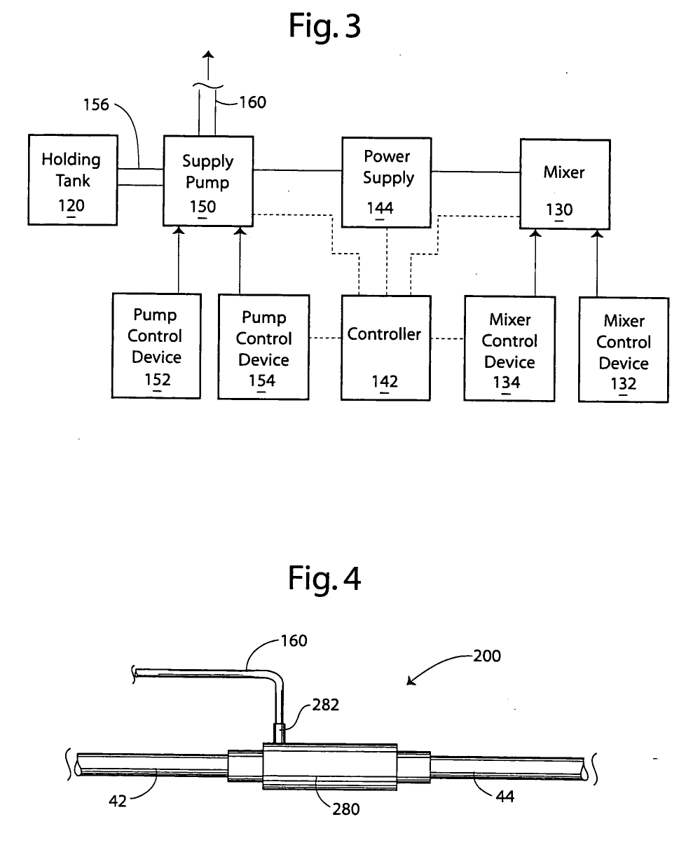

With reference to FIGS. 2 and 3, the flocculant supply system 100 includes a support frame 110. A holding tank 120 and a cabinet 140 are securely mounted on the frame 110. The frame 110 includes handling hooks 112 or the like and the system 100 is portable using a suitable lift and conveying apparatus. The holding tank 120 may be secured to the frame 110 by tie down straps 114, for example.

The holding tank 120 may be formed of any suitable material. According to some embodiments, the holding tank 120 is formed of a polymeric material. According to some embodiments, the capacity volume of the holding tank 120 is at least 25 gallons. According to some embodiments, the volume capacity of the holding tank 120 is between about 25 and 2,000 gallons.

A mixing device or mixer 130 is operably mounted on the holding tank 120. The mixer 130 includes a drive unit such as an electric motor, a driven shaft extending from the drive unit into the holding tank 120, and an impeller or suitable displacer on the shaft in the holding tank 120. The mixer 130 may be powered by a power supply 144 as described below.

A supply pump 150 is disposed in the cabinet 140. The supply pump 150 may be any suitable type of pump. According to some embodiments, the supply pump 150 is a peristaltic pump. An intake conduit 156 fluidly connects the holding tank 120 and the intake of the supply pump 150. An output conduit 160 fluidly connects the output of the supply pump 150 to the intake 40A of the transfer pump 40. According to some embodiments and as shown, the conduit 160 is inserted into the conduit 42 through the intake end 42A so that the conduit 160 is fluidly connected to the intake 40A of the pump 40 by the conduit 42. Exemplary supply pumps include the peristaltic pumps available from Randolf Austin Pumps of Texas. The supply pump 150 may be powered by the power supply 144 described below.

The power supply 144 is also disposed in the cabinet 140. The power supply 144 may be any suitable power supply. According to some embodiments, the power supply 144 includes a battery and is capable of providing power sourced from the battery and/or an external power line (e.g., 110 volt AC) via an electrical feed socket connector 146 (FIG. 2) mounted on the cabinet 140. According to some embodiments, the power supply 144 includes a battery charger operative to charge the battery from the external power line supply.

A mixer control device 132 such as a control knob is provided on the mixer 130. A further mixer control device 134 is provided on the cabinet 140. A timer may also be provided to control the mixer 130.

A first pump control device 152 is provided on the cabinet 140 for convenient access by an operator. A second pump control device 154 is mounted inside the cabinet 140 where operator access may be limited or restricted. This arrangement may be used so that an administrator or set-up technician can set limiting parameters for the operation of the pump using the pump control device 154 and the operator can operate the pump 150 as needed using the pump control device 152.

According to some embodiments, the flocculant supply system 100 includes a controller 142 (FIG. 3) which may be an electronic controller such as a programmable logic computer (PLC) to control the operation of the mixer 130 and/or the supply pump 150. The system 100 may also include a display (not shown). The controller 142 may incorporate a timer, limit settings, preconfigured settings, etc., and may provide for automatic or semi-automatic operation. The controller 142 may receive the inputs from the control devices and operate the mixer 130 and the supply pump 150 in accordance therewith.

The storm water decontamination system 10 may be used in the following manner in accordance with methods of the present invention. A desired amount of water and a corresponding desired amount of water-soluble flocculant are placed in the holding tank 120. According to some embodiments, the solvent water is substantially clean water that does not include a significant amount of particles that might aggregate with the flocculant.

The flocculant may be any suitable flocculant. Suitable flocculants may include cationic polyacrylamide, anionic polyacrylamide, or biopolymer. According to some embodiments, the flocculant is a long chain polymer flocculant. Suitable long chain polymer flocculants include polyacrylamide. According to some embodiments, the flocculant is a high molecular weight polyacrylamide flocculant. Examples of suitable flocculants include Geofloc 2200™ flocculant available from GeoSpec, Inc. of Raleigh, N.C. In particular, according to some embodiments, the flocculant is a flocculant that requires a prescribed amount of time and/or agitation to dissolve into the water. The flocculant may be provided as granules or powders, for example.

The mixer 130 is then operated to mix the water and the flocculant in the holding tank 120 until the flocculant is suitably dissolved or made down into the water to form the pre-mixed flocculant solution 102. According to some embodiments, the flocculant is fully dissolved into the water. Once the flocculant is fully dissolved, it typically will not be necessary to further mix the water and the flocculant to maintain the solution 102 and the mixer 130 can be turned off. According to some embodiments, the mixer 130 is turned off at this point to prevent damaging the dissolved flocculant (which may render the flocculant less effective). In the case of a long chain polymer flocculant, the flocculant may dissolve by unwinding or uncoiling. The pre-mixed flocculant solution 102 thus includes the flocculant in a condition such that the flocculant is readily available to attach to particles. According to some embodiments, the concentration of the flocculant in the flocculant solution is at least about 0.1 percent by weight and, according to some embodiments, between about 0.1 and 0.5 percent by weight.

The transfer pump 40 is operated to pump a flow of the dirty water 20 from the basin 32 to the filtering system 51. As the transfer pump 40 is operated, the supply pump 150 is also operated. The supply pump 150 draws the pre-mixed flocculant solution 102 from the holding tank 120 and injects the pre-mixed flocculant solution 102 into the flow of the dirty water 20 at the intake side of the transfer pump 40.

As the dirty water 20 and the solution 102 are forced through the transfer pump 40, they are mixed with one another, and may be additionally mixed by downstream turbulence in the water flow. As the dirty water 20 and the solution 102 mix, the flocculant of the solution 102 contacts and aggregates with particles of the dirty water 20 to form flocs. In this manner, the dirty water 20 is converted to the treated water 22.

The treated water 22 passes through the conduit 44 to a basin 50 of the filtering system 51. The filtering system 51 may include filter curtains 52 as baffles to filter the flocs from the treated water 22 and absorb energy from the treated water 22 to reduce turbulence in the basin 50. In the basin 50, the flocs also settle out of the treated water 22. At the far end of the basin 50, clarified water 24A from a top portion of the water in the basin 50 is discharged through a gravity drain 54 to the environment. Alternatively, a removal pump (not shown) may be used to draw the clarified water 24A from the top portion.

As an alternative or in addition to the filtering system 51, a filtering system 61 (FIG. 1) may be employed. In this case, the treated water 22 is directed into and through a filter bag 60 via a conduit 46. The filter bag 60 captures the flocs and other large particles and allows the clarified water 24B to flow out to the environment. The filter bag 60 may be formed of, for example, 8 oz., 10 oz., or 12 oz. nonwoven geotextile.

As further alternatives, the flocs may be removed from the treated water 22 by biofiltration, sand filtration, or the use of other types of filters (e.g., cartridge filters).

In accordance with embodiments of the present invention, the ratio or proportion of the flocculant in the pre-mixed flocculant solution 102 is selected to achieve a relatively specific and desired amount of flocculant in the treated water 22 (i.e., a desired flocculant to water ratio in the treated water 22). This flocculant-to-water ratio of the treated water 22 may be set by adjusting the flow rate of the solution (using the pump 150), adjusting the flow rate of the dirty water 20 through the transfer pump 40, and/or adjusting the concentration of the flocculant in the pre-mixed flocculant solution 102. However, the latter adjustment may be limited by the saturation point of the flocculant in the water of the solution 102.

By way of example, an operator may wish to transfer and process the dirty water 20 at a given volumetric flow rate and will set the transfer pump 40 at this rate, or the transfer pump 40 itself may dictate a given rate. The operator may then set or select the flocculant concentration in the solution 102 and the injection rate provided by the supply pump 150 to achieve the desired concentration of the flocculant in the treated water 22. Because the flow into which the flocculant solution is injected can be controlled and can have a relatively small cross-sectional area, the ratio of flocculant-to-water can be accurately controlled and the flocculant can be uniformly dispersed in the dirty water 20.

In accordance with embodiments of the present invention, the storm water decontamination system 10 may be used to provide suitably precise and controlled metering of the flocculant into the dirty water 20 by use of the adjustments listed above. As a result, the concentration of the flocculant in the treated water 22 can be controlled and readily determined without requiring measurement of the flocculant in the treated water 22, which may not be possible or practicable. For example, the process can be tailored such that the flocculant concentration in the treated water 22 does not exceed the maximum concentration allowed per applicable regulations.

The flocculant can be delivered in a uniform and controlled manner so that the flocculant is efficiently consumed by the particles of the dirty water 20. This may serve to reduce waste of the flocculant and also to prevent or reduce the risk of non-aggregated flocculant being discharged into the environment. According to some embodiments, the concentration of the flocculant in the treated water 22 is selected such that particles not aggregated with flocculant remain in the treated water 22, thereby assuring that excess flocculant is not introduced into the dirty water 20 and ultimately discharged into the environment non-aggregated.

According to some embodiments, the concentration of the flocculant in the treated water 22 is no more than about 5 ppm. According to some embodiments, the concentration is between about 0.2 and 5 ppm. According to some embodiments, the flocculant provided in the foregoing concentrations is a long chain polymer flocculant. According to some embodiments, the long chain polymer flocculant includes polyacrylamide.

According to some embodiments, the turbidity of the treated water 22 is reduced to meet or comply with applicable required guidelines such as those imposed by a governmental environmental regulation agency. According to some embodiments, the turbidity is reduced to less than about 100 Nephelometric Turbidity Units (NTU).

With reference to FIG. 4, a fragmentary, schematic view of a flocculant supply system 200 according to further embodiments of the present invention is shown therein. The system 200 differs from the storm water decontamination system 100 in that a static inline mixer 280 is provided in one of or between the conduits 42 and 44. The injection conduit 160 from the flocculant supply pump 150 is connected to an intake of the inline mixer 280. The pre-mixed flocculant solution 102 is injected and mixed with the flow of the dirty water 20 by the inline mixer 280. This configuration may be used in addition to or in place of a transfer pump. For example, this configuration may be employed where the flow through the conduits 42, 44 is provided by a gravity feed.

The system described herein may be modified in accordance with further embodiments of the present invention. For example, one or more supply pumps may be provided in parallel with the supply pump 150 to supply the flocculant solution 102 to the intake side of the transfer pump 40. Such additional supply pumps may draw flocculant solution from the same tank 120 or from one or more additional tanks. For example, multiple flocculant supply systems 100 may be used in parallel to provide the desired flow rate of flocculant solution. Thus, the supply rate of the flocculant solution can scaled by modularly combining two or more of the flocculant supply systems 100.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention. Therefore, it is to be understood that the foregoing is illustrative of the present invention and is not to be construed as limited to the specific embodiments disclosed, and that modifications to the disclosed embodiments, as well as other embodiments, are intended to be included within the scope of the invention.

That which is claimed is:

1. A method for removing contaminant particles from storm water, the method comprising:
providing a pre-mixed flocculant solution including a water-soluble flocculant and a quantity of solvent water; and thereafter
mixing the pre-mixed flocculant solution with the storm water to form treated water wherein flocculants of the pre-mixed flocculant solution are bound with the contaminant particles in the storm water to form flocculated particles.

2. The method of claim 1 including mixing the water-soluble flocculant in the quantity of the solvent water for at least a prescribed amount of time to form the pre-mixed flocculant solution prior to mixing the pre-mixed flocculant solution with the storm water to form the treated water.

3. The method of claim 1 including selectively controlling the amount of flocculant in the treated water.

4. The method of claim 3 wherein a concentration of the flocculant in the treated water is in the range of from about 0.2 to 5 ppm.

5. The method of claim 1 further including removing the flocculated particles from the treated water to form clarified water.

6. The method of claim 5 wherein removing the flocculated particles from the treated water includes passing the treated water through a filter.

7. The method of claim 5 wherein removing the flocculated particles from the treated water includes placing the treated water in a settling basin where the flocculated particles settle to form the clarified water and removing the clarified water from the basin.

8. The method of claim 5 including releasing the clarified water to the environment.

9. The method of claim 1 including pumping the pre-mixed flocculant solution into a flow of the storm water.

10. The method of claim 1 including:
pumping the storm water using a pump; and
introducing the pre-mixed flocculant solution into the storm water via an intake of the pump such that the pre-mixed flocculant solution and the storm water are mixed by the pump.

11. The method of claim 1 including:
flowing the storm water through a conduit via a gravity feed; and
introducing the pre-mixed flocculant solution into the storm water and mixing the pre-mixed flocculant solution with the storm water via an inline mixer along the conduit.

12. An apparatus for removing contaminant particles from storm water, the apparatus comprising:
a holding tank adapted to contain a pre-mixed flocculant solution including a water-soluble flocculant and a quantity of solvent water; and
a treatment system adapted to mix the pre-mixed flocculant solution from the holding tank with the storm water to form treated water wherein flocculants of the pre-mixed flocculant solution are bound with the contaminant particles in the storm water to form flocculated particles.

13. The apparatus of claim 12 including a quantity of the pre-mixed flocculant solution disposed in the holding tank.

14. The apparatus of claim 12 including a mixing device to mix the flocculant with the quantity of solvent water in the holding tank.

15. The apparatus of claim 12 including a metering system adapted to selectively control the amount of flocculant in the treated water.

16. The apparatus of claim 15 wherein the metering system is adapted to selectively control the amount of flocculant in the treated water such that a concentration of the flocculant in the treated water is in the range of from about 0.1 to 0.5 percent by weight.

17. The apparatus of claim 15 wherein the metering system includes a metering pump.

18. The apparatus of claim 12 including an injection pump adapted to inject the pre-mixed flocculant solution into a flow of the storm water.

19. The apparatus of claim 12 including:
a transfer pump to pump the storm water, the transfer pump having an intake; and
a feed line configured to introduce the pre-mixed flocculant solution into the storm water via the intake such that the pre-mixed flocculant solution and the storm water are mixed by the transfer pump.

20. The apparatus of claim 12 including:
a conduit through with the storm water can be flowed via a gravity feed; and
an inline mixer along the conduit, wherein the apparatus is adapted to introduce the pre-mixed flocculant solution into the storm water and mix the pre-mixed flocculant solution with the storm water via the inline mixer.

21. The apparatus of claim 12 including:
a mixing device to mix the flocculant with the quantity of solvent water in the holding tank;
an injection pump adapted to inject the pre-mixed flocculant solution into a flow of the storm water; and
a support frame, wherein the holding tank, the mixing device, and the injection pump are each mounted on the support frame to form a portable assembly.

22. The apparatus of claim 21 including a power supply including a battery and a battery charger.

23. The apparatus of claim 12 further including a removal system to remove the flocculated particles from the treated water to form clarified water.

24. The apparatus of claim 23 wherein the removal system includes a filter.

25. The apparatus of claim 23 wherein the removal system includes a settling basin where the flocculated particles can settle to form the clarified water.
